(19) United States
(12) Patent Application Publication
(10) Pub. No.: US 2023/0183484 A1
(43) Pub. Date: Jun. 15, 2023

(54) SILICONE-EPOXY COMPOSITIONS AND PROTECTIVE COATINGS

(71) Applicant: Nanophos SA, Lavrio (GR)

(72) Inventor: Ioannis ARAMPATZIS, Lavrio (GR)

(73) Assignee: NanoPhos SA, Lavrio (GR)

(21) Appl. No.: 17/926,489

(22) PCT Filed: May 25, 2020
(86) PCT No.: PCT/GR2020/000026

§ 371 Date: Nov. 18, 2022

(51) Int. Cl. C08L 83/10; C08K 5/5445; C08K 3/32; C09D 183/04; C09D 163/00

(52) U.S. Cl. CPC C08L 83/10; C08K 5/5445; C08K 3/32; C09D 183/04; C09D 163/00; C08K 2003/321; C08K 2003/2296

(57) ABSTRACT

Provided are silicone-epoxy compositions, protective coatings formed from silicone-epoxy compositions, and methods of preparing the same.

### CROSS REFERENCE TO RELATED APPLICATIONS

This application is a U.S. national stage application under 35 U.S.C. § 371 of International Application No. PCT/GR2020/000026, filed May 25, 2020.

### FIELD OF THE DISCLOSURE

This disclosure relates to silicone-epoxy protective coatings for marine, industrial, and/or aviation applications.

### BACKGROUND OF THE DISCLOSURE

Protective coatings, and in particular, protective coatings for marine, industrial, and/or aviation applications, can be applied on a variety of surfaces (metal, glass, coated substrates) to provide durable, slippery, reduced micro-roughness surfaces and reduce wear/abrasion. These friction-reducing coatings can additionally prevent corrosion, be chemically inert, and easy to clean.

Low friction coatings in the marine and/or aviation industry are essential. Fuel consumption is the most significant cost fraction in vessels' operation, accounting for up to 50% of the total ship operating costs. Low friction coatings can help lower fuel consumption. In particular, the efficiency of modern aviation transportation is severely compromised by the prevalence of turbulent drag and icing. The high level of turbulent skin-friction occurring on the surface of an airplane's airfoil and/or fuselage is responsible for excess fuel consumption and increased carbon emissions. Even in industrial applications (e.g., hydroelectric power plant penstocks and wind turbines for electricity generation), friction is an efficiency loss detrimental factor.

The amount of friction, characterized by the friction coefficient value between a solid and a fluid depends on many parameters such as the mechanical, physical, and/or chemical properties of materials in contact, the value of the contact pressure, the contact surface roughness, the mutual dissolution of materials in contact, the contact time, the elasticity of tribo-system, the presence of the extraneous bodies in contact zone, etc. However, the intrinsic tribological properties of materials are mainly and mostly dependent on two sole physical parameters: surface roughness and surface tension.

For liquid-solid interactions (e.g., penstocks, vessels' hull, marine propellers, airfoils) specialty coatings with low friction, precisely tuned surface tension, and low roughness are essential, as fouling release properties are expressed. Fouling release coatings are an important alternative to conventional, self-polishing and antifouling formulations, as they simultaneously reduce drag, fuel consumption rate, and can prevent fouling growth without the use of biocidal ingredients. Fowling growth on airfoils is defined as the airfoil surface contamination by soiling, organic deposits, icing, insect collision debris, or any other contamination that would result in solids depositions and surface micro- or macro-roughness increase. Non-stick fouling release coatings are based on a technology that prevents the adhesion of fouling organisms or elements by providing a low-friction, ultra-smooth surface on which fouling organisms or elements can present great difficulty in adhering.

For example, sea propellers are essential for a vessels' performance because they produce thrust. Propellers are often unprotected and prematurely lose their original polished surface texture. Roughening of propeller blade surfaces may be caused by marine growth, impingement attack, electrochemical corrosion, and/or cavitation erosion. Proper surface roughness maintenance can result in a 3-5% decrease in fuel consumption. Therefore, a special propeller coating with low roughness characteristics, low surface tension, and extremely low roughness can quickly increase vessel performance.

For example, the blade airfoils of wind turbines are the most vital element to spin a shaft that is connected through a gearbox to the electricity generator and, eventually, produce electrical energy. The blade airfoils are most often unprotected and prematurely lose their original coated surface texture. Erosion or fouling of airfoil blade surfaces may be caused by soiling, organic deposits, icing, insect collision debris, or any other contamination. This results in losing 4-5% of the original power generation efficiency. Additionally, icing (ice formation) results in wind turbine vibrations and, subsequently, poses a structural integrity threat for the whole wind turbine installation. Therefore, a unique blade airfoil coating with low roughness characteristics, low surface tension, and extremely high fouling release properties would result in higher efficiency and more significant energy harvesting.

### SUMMARY OF THE DISCLOSURE

Provided herein are silicone-epoxy formulations, silicone-epoxy protective coatings, and methods of preparing silicone-epoxy formulations and protective coatings. Silicone-epoxy protective coatings disclosed herein having low friction, hydrophobic, anti-icing, fouling release, and/or anti-corrosive properties may be used for marine, industrial, and/or aviation applications, including, but not limited to, hydro-energy plants penstocks, wind energy converters, manned or unmanned aerial vehicles, rotors, offshore platforms, vessels, and/or fans/propellers that transmit power. Silicone-epoxy protective coatings provided herein may provide low surface tension and reduced roughness that may result in improved friction, hydrophobic, anti-icing, easy-cleaning, anti-graffiti, fouling release and anti-corrosive properties compared to conventional marine and/or aviation coatings. Formulations and coatings disclosed herein may be suitable for use in corrosive, abrasive, and/or temperature-extreme environments. Further, formulations and coatings provided present excellent adhesion properties on the substrate applied. In some embodiments, no primer coating is required before the application of disclosed formulations on a substrate.

Silicone-epoxy compositions provided herein may comprise a silicone-epoxy resin, a rheology additive, a defoaming agent, and an amino-based silane. Optionally, silicone-epoxy compositions provided herein may additionally comprise an ultraviolet absorber, organic solvents, metal oxides, an epoxy resin comprising an elastomer, and an organic algicide or fungicide. Coatings that are prepared using formulations provided herein may be solid, highly dense, having few, if any, surface imperfections, cured without any heating process required, highly impact-resistant, adhered on a substrate without the need of a primer, flexible, corrosion-resistant, having low surface tension and fouling release, and/or presenting roughness R_{z} (R_{z} is the average distance between the highest peak and lowest valley in each sampling length, The American Society of Mechanical Engineers (ASME) publication Y14.36-2018: Surface Texture Symbols) of less than 40 micrometers.

In some embodiments, a silicone-epoxy coating formulation composition includes 45-80 wt. % silicone-epoxy resin; 0.05-10 wt. % biocide, 0.05-0.3 wt. % rheology additive, 5-18 wt. % solvent, and 10-30 wt. % amino-silane. In some embodiments, the rheology additive comprises at least one of TEGO® Flow 425, TEGO® Glide 100, or AEROSIL® 200. In some embodiments, the solvent comprises at least one of butyl acetate, xylene, methoxy propyl acetate, or glycol esters. In some embodiments, the composition includes 0.05 to 1 wt. % ultraviolet absorber. In some embodiments, the ultraviolet absorber comprises at least one of Tinuvin® 400 or Tinuvin® 1130 or Milestab® 234. In some embodiments, the composition includes 0.1 to 0.4 wt. % defoaming additive. In some embodiments, the defoaming additive comprises at least one of BYK®-A 500 or TEGO® Foamex 810 or TEGO® Foamex 825 or TEGO® Foamex 830. In some embodiments, the composition includes 0.05 to 20 wt. % metal oxide or phosphate. In some embodiments, the composition includes 0.05 to 10 wt. % epoxy resin comprising an elastomer.

In some embodiments, a silicone-epoxy coated substrate includes a substrate and a coating on the substrate, wherein the coating includes 70-95 wt. % amino-silane cross-linked silicone-epoxy resin, 0.05-12 wt. % biocide, and 0.05-0.4 wt. % rheology additive. In some embodiments, the rheology additive comprises at least one of TEGO® Flow 425, TEGO® Glide 100, or AEROSIL® 200. In some embodiments, the coating includes 0.05 to 25 wt. % metal oxide or phosphate. In some embodiments, the coating includes 0.05 to 1.5 wt. % ultraviolet absorber. In some embodiments, the ultraviolet absorber comprises at least one of Tinuvin® 400 or Tinuvin® 1130 or Milestab® 234. In some embodiments, the coating includes 0.1 to 0.5 wt. % defoaming additive. In some embodiments, the defoaming additive comprises at least one of BYK®-A 500 or TEGO® Foamex 810 or TEGO® Foamex 825 or TEGO® Foamex 830. In some embodiments, the coating has a roughness R_{z} of less than 30 micrometers. In some embodiments, the substrate comprises one or more of a hydro-energy plant penstock, a wind energy converter, a manned or unmanned aerial vehicle, an airfoil, a vehicle fuselage, a rotor, an offshore platform, a vessel, or a fan/propeller that transmits power. In some embodiments, coating has a roughness (R_{z}) of less than 50. In some embodiments, the coating has a roughness (R_{z}) of less than 40.

### BRIEF DESCRIPTION OF THE FIGURES

The patent or application file contains at least one drawing executed in color. Copies of this patent or patent application publication with color drawings will be provided by the office upon request and payment of the necessary fee.

The invention will now be described, by way of example only, with reference to the accompanying drawings, in which:

FIG. 1 shows the preparation pathway schematic representation of a final composition, according to some embodiments;

FIGS. 2A and 2B shows two application examples of the final composition (2A) application on a metal propeller and (2B) application on a metallic plate, according to some embodiments;

FIG. 3 shows a wooden model constructed for testing of hydrodynamic performance, according to some embodiments;

FIG. 4 shows resistance versus speed data, obtained from the hydrodynamic testing, according to some embodiments;

FIG. 5 shows the result after cross-cut testing, according to some embodiments, alongside with the evaluation scheme, as per ISO 2409:2013 (Paints and varnishes Cross-cut test);

FIG. 6 shows the results after cylindrical bend testing according to some embodiments;

FIG. 7 shows the results after impact testing according to some embodiments;

FIG. 8 presents the “Baier Curve”: Degree of biological fouling, versus critical surface tension of polymeric substrates. Retrieved by data in R. E. Baier, J Mater Sci Mater Med. 2006 November; 17(11):1057-62;

FIG. 9 shows Water Contact Angle for a surface created according to some embodiments;

FIG. 10 shows an application of the disclosed coating on the hull of a Suezmax tanker vessel (white hull coating), according to some embodiments;

FIG. 11 shows fuel consumption vs. speed data for two datasets, according to some embodiments;

FIG. 12 provides airfoil models for aerodynamic evaluation of silicone-epoxy formulations coatings, according to some embodiments; and

FIGS. 13A and 13B provides (13A) lift coefficient and (13B) lift-to-drag ratio diagrams, as a function of airfoil models angle of attack, according to some embodiments.

### DETAILED DESCRIPTION OF THE DISCLOSURE

Provided herein are silicone-epoxy formulations, silicone-epoxy protective coatings, and methods of preparing silicone-epoxy formulations and protective coatings. The silicone-epoxy formulations and protective coatings described herein may be used for marine, industrial, and/or aviation applications, including, but not limited to, hydro-energy plants penstocks, wind energy converters, manned or unmanned aerial vehicles, rotors, offshore platforms, vessels, and/or fans/propellers that transmit power.

Specifically, the silicone-epoxy compositions and protective coatings described herein may have desirable properties for specific applications. For example, such features may include low friction, hydrophobic, anti-icing, fouling release, and/or anti-corrosive properties. In particular, protective coatings provided herein may provide low surface tension and reduced roughness that may result in improved friction, hydrophobic, anti-icing, easy-cleaning, anti-graffiti, fouling release, and anti-corrosive properties compared to conventional marine and/or aviation coatings. As described above, coatings comprising some and/or all of these properties can help reduce friction, which is particularly beneficial in marine and aviation applications. Additionally, the compositions described herein present excellent adhesion properties on the substrate applied. In some embodiments, no primer coating is required before the application of disclosed formulations on a substrate.

To achieve the disclosed silicone-epoxy compositions and coatings having the above-described properties, a preparation method comprising two separate components is used. The first component, or liquid base, comprises a silicone-epoxy resin, a rheology additive, and a defoaming agent. The liquid base may also include a liquid UV absorber, organic solvents, metal oxides, an epoxy resin comprising an elastomer, and an algicide or fungicide. The second component, or hardener, comprises amino-based silane. This preparation method is described in further detail below.

The resulting composition, when applied to as a coating onto a surface, can provide low roughness and low surface tension. The final coating meets the necessary criteria for use in harsh conditions, such as the marine environment. The produced system is used for the preparation of a coating on the top of metallic surfaces, providing the following characteristics: (a) solid, high-density coating, without surface imperfections, (b) absence of post-deposition heating step, (c) possibility of absence of post-primer-coat step, (d) high impact resistance, (e) high adhesion, (f) flexibility, (g) corrosion-resistant (i) fouling-release behavior and (h) high surface smoothness.

### Silicone-Epoxy Composition

Silicone-epoxy compositions provided herein may comprise a silicone-epoxy resin, a rheology additive, a defoaming agent, and amino-silane. In some embodiments, silicone-epoxy compositions provided herein may also comprise an ultraviolet absorber, a metal oxide, an epoxy resin containing or consisting of an elastomer, an algicide, or fungicide, and/or a solvent. Each component is described in detail below.

Silicone-epoxy compositions provided herein comprise a silicone-epoxy resin.

Silicone-epoxy resins are silicone-based polymers with epoxy functional groups. They can allow for efficient cross-linking with curing agents (e.g., amino-silane). In some embodiments, the silicone-epoxy resin may be aliphatic, which can provide suitable commercially-available silicon-epoxy resins that can include SILIKOPON® EF or SILIKOFTAL® ED, or SILIKOPON® EW, or IOTA® H-30, or IOTA® H-60. In some embodiments, silicone-epoxy compositions provided herein may comprise from 45-85 wt. %, 55-75 wt. %, or 60-70 wt. % silicone-epoxy resin. In some embodiments, silicone-epoxy compositions provided herein may comprise less than or equal to 85 wt. %, less than or equal to 80 wt. %, less than or equal to 75 wt. %, less than or equal to 70 wt. %, less than or equal to 65 wt. %, less than or equal to 60 wt. %, less than or equal to 55 wt. %, or less than or equal to 50 wt. % silicone-epoxy resin. In some embodiments, silicone-epoxy compositions provided herein may comprise more than or equal to 45 wt. %, more than or equal to 50 wt. %, more than or equal to 55 wt. %, more than or equal to 60 wt. %, 65 wt. %, more than or equal to 70 wt. %, more than or equal to 75 wt. %, or more than or equal to 80 wt. % silicone-epoxy resin.

Silicone-epoxy compositions provided herein comprise a rheology additive. Rheology additives are often used to thicken a liquid composition to achieve specific rheological properties of the composition, including preventing sagging during application, to adjust thickness upon application, to facilitate spreading, to improve leveling, and/or to prevent sedimentation of filler. Suitable commercially-available rheology additives can include TEGO® Flow 425, TEGO® Glide 100, or AEROSIL® 200. Silicone-epoxy resins comprising too much, or too little rheology additive may exhibit undesirable flow/rheologic properties. In some embodiments, silicone-epoxy compositions provided herein may comprise 0.05-0.5 wt. % or 0.1-0.2 wt. % rheology additive. In some embodiments, silicone-epoxy compositions may comprise less than or equal to 0.5 wt. %, less than or equal to 0.4 wt. %, less than or equal to 0.3 wt. %, less than or equal to 0.2 wt. %, or less than or equal to 0.1 wt. % rheology additive. In some embodiments, silicon-epoxy compositions provided herein may comprise more than or equal to 0.05 wt. %, more than or equal to 0.1 wt. %, more than or equal to 0.2 wt. %, more than or equal to 0.3 wt. %, or more than or equal to 0.4 wt. % rheology additive.

Silicone-epoxy compositions provided herein comprise a defoaming agent. Defoaming agents (e.g., anti-foaming agents) are chemical additives that hinder the formation of foam in a liquid composition. Suitable commercially-available defoaming agents can include BYK®-A 500 or TEGO® Foamex 810 or TEGO® Foamex 825 or TEGO® Foamex 830. Silicone-epoxy compositions that comprise too little defoaming agent may lead to coatings having air bubbles and/or other imperfections. Silicone-epoxy compositions having too much defoaming agent may have compromised properties due to the higher levels of the defoaming agent. In some embodiments, silicone-epoxy compositions provided herein may include 0.1-0.4 wt. % defoaming agent. In some embodiments, silicone-epoxy compositions provided herein may include less than or equal to 0.4 wt. %, less than or equal to 0.3 wt. %, or less than or equal to 0.2 wt. % defoaming agent. In some embodiments, silicone-epoxy compositions provided herein may include more than or equal to 0.1 wt. %, more than or equal to 0.2 wt. %, or more than or equal to 0.3 wt. % defoaming agent.

Silicone-epoxy compositions provided herein comprise an amino-silane. Amino-functional silanes possess a reactive amino group and a hydrolyzable alkoxysilyl group. The dual nature of this reactivity allows amino-silanes to bind chemically to both inorganic materials (e.g., glass, metals, and fillers) and organic polymers (e.g., thermosets, thermoplastics, elastomers). Amino-silanes can serve as adhesion promoters, curing agents, coupling agents, surface modifiers, and/or a resin additive. Amino-silanes can improve the chemical bonding of resins to inorganic fillers and reinforcing materials and can be used with epoxies, such as the silicone-epoxy compositions described herein. For example, amino-silanes that may be used in silicone-epoxy compositions provided here include aliphatic amino-silane-based compounds of chemical composition (CₖH₂ₖ₊₁O)(CₗH₂ₗ₊₁O)(CₘH₂ₘ₊₁O)(CₙH₂ₙ₊₂N)Si or (CₖH₂ₖ₊₁O)₂(CₗH₂ₗ₊₁O)₂(CₘH₂ₘ₊₁O)₂(CₙH₂ₙ₊₁N)Si₂, wherein k, l, m, n can be any positive integer numbers from 1 to 20, such as (5-Aminobutyl)tripentylsilane.

Suitable commercially-available amino-silanes can include Dynasylan® AMEO, Gelest® SIB1833.0, and Dow Corning® Z-6011. Silicone-epoxy compositions comprising too much or too little amino-silane may have undesirable adhesive properties (i.e., too adhesive or not adhesive enough). In some embodiments, silicone-epoxy compositions provided herein may comprise 10-30 wt. % amino-silane. In some embodiments, silicone-epoxy compositions may comprise less than or equal to 30 wt. %, less than or equal to 25 wt. %, less than or equal to 20 wt. %, or less than or equal to 15 wt. % amino-silane. In some embodiments, silicone-epoxy compositions may comprise more than or equal to 10 wt. %, more than or equal to 15 wt. %, more than or equal to 20 wt. %, or more than or equal to 25 wt. % amino-silane.

In some embodiments, silicone-epoxy compositions provided herein may comprise an ultraviolet absorber. Ultraviolet absorbers and/or light stabilizers can provide protection against ultraviolet light. They can be designed to protect and extend the lifetime of coatings, such as the silicone-epoxy protective coatings provided herein. Suitable ultraviolet absorbers can include Tinuvin® 400 or Tinuvin® 1130 or Milestab© 234. Silicone-epoxy compositions that include too little ultraviolet absorber may not be able to form coatings with suitable ultraviolet protection and lifespan. Silicone-epoxy compositions that have too much ultraviolet absorber may have compromised properties due to the excess amount of ultraviolet absorber. In some embodiments, silicone-epoxy compositions may comprise 0.05 to 1 wt. % ultraviolet absorber. In some embodiments, silicone-epoxy compositions may comprise less than or equal to 1 wt. %, less than or equal to 0.8 wt. %, less than or equal to 0.6 wt. %, less than or equal to 0.4 wt. %, less than or equal to 0.2 wt. %, or less than or equal to 0.1 wt. % ultraviolet absorber. In some embodiments, silicone-epoxy compositions may comprise more than or equal to 0.05 wt. %, more than or equal to 0.1 wt. %, more than or equal to 0.2 wt. %, more than or equal to 0.4 wt. %, more than or equal to 0.6 wt. %, or more than or equal to 0.8 wt. % ultraviolet absorber.

In some embodiments, silicone-epoxy compositions provided herein may comprise one or more metal oxides or phosphates. Metal oxides and/or phosphates can help prevent premature and/or excessive corrosion of silicon-epoxy protective coatings provided herein. When metal oxides/phoshates are incorporated into epoxy resins, the corrosion rate can be reduced because the particles can occupy small defects and consequently can increase the cross-linking density. This increase in cross-linking density can cause improved durability of the coating. Suitable metal oxides include titanium dioxide, zinc oxide, tin(IV) oxide, SiO₂, Fe₂O₃, and their mixtures. Silicone-epoxy compositions comprising too much or too little metal oxide/phosphate may not have desirable anti-corrosive properties. In some embodiments, silicone-epoxy compositions provided herein may comprise 0.05-20 wt. % or 5-10 wt. % metal oxide and/or phosphate. In some embodiments, silicone-epoxy compositions may comprise less than or equal to 20 wt. %, less than or equal to 15 wt. %, less than or equal to 10 wt. %, less than or equal to 5 wt. %, or less than or equal to 1 wt. % metal oxide and/or phosphate. In some embodiments, silicone-epoxy compositions may comprise more than or equal to 0.05 wt. %, more than or equal to 0.1 wt. %, more than or equal to 1 wt. %, more than or equal to 5 wt. %, more than or equal to 10 wt. %, or more than or equal to 15 wt. % metal oxide and/or phosphate.

In some embodiments, silicone-epoxy compositions may include an epoxy resin. In some embodiments, the epoxy resin may comprise an elastomer. Suitable commercially-available epoxy resins can include ALBIDUR® EP 2240 A. In some embodiments, silicone-epoxy compositions may include 0.05-10 wt. % epoxy resin. In some embodiments, silicone-epoxy compositions may include less than or equal to 10 wt. %, less than or equal to 8 wt. %, less than or equal to 6 wt. %, less than or equal to 4 wt. %, less than or equal to 2 wt. %, less than or equal to 1 wt. %, or less than or equal to 0.5 wt. % epoxy resin. In some embodiments, silicone-epoxy compositions may include more than or equal to 0.05 wt. %, more than or equal to 0.1 wt. %, more than or equal to 0.5 wt. %, more than or equal to 1 wt. %, more than or equal to 2 wt. %, more than or equal to 4 wt. %, more than or equal to 6 wt. %, or more than or equal to 8 wt. % epoxy resin.

In some embodiments, silicone-epoxy compositions provided herein may comprise an algicide and/or a fungicide. Algicides are biocides that are designed to kill and/or prevent the growth of algae. Fungicides are biocides that are designed to kill parasitic fungi and their spores. For example, suitable commercially-based algicides and/or fungicides can include 4,5-Dichloro-2-octylisothiazol-3(2H)-one, Irgarol®, Tralopyril (Econea®) and Medetomide (Selektope®). Silicone-epoxy compositions provided herein that comprise too little algicide and/or fungicide may not achieve a protective coating that can adequately protect against algae and fungal growth. In some embodiments, silicone-epoxy compositions may include 0.05-10 wt. % biocide. In some embodiments, silicone-epoxy compositions may include less than or equal to 10 wt. %, less than or equal to 8 wt. %, less than or equal to 6 wt. %, less than or equal to 4 wt. %, less than or equal to 2 wt. %, less than or equal to 1 wt. %, or less than or equal to 0.5 wt. % biocide. In some embodiments, silicone-epoxy compositions may include more than or equal to 0.05 wt. %, more than or equal to 0.1 wt. %, more than or equal to 0.5 wt. %, more than or equal to 1 wt. %, more than or equal to 2 wt. %, more than or equal to 4 wt. %, more than or equal to 6 wt. %, or more than or equal to 8 wt. % biocide.

In some embodiments, silicone-epoxy compositions may include a solvent. For example, suitable solvents can include butyl acetate, xylene, methoxy propyl acetate, glycol esters. In some embodiments, a silicone-epoxy composition may comprise 1-25 wt. % or 5-15 wt. % solvent (the concentrations referred to Base A). In some embodiments, a silicone-epoxy composition may comprise less than or equal to 25 wt. %, less than or equal to 20 wt. %, less than or equal to 15 wt. %, less than or equal to 10 wt. %, or less than or equal to 5 wt. % solvent. In some embodiments, a silicone-epoxy composition may comprise more than or equal to 1 wt. more than or equal to 5 wt. %, more than or equal to 10 wt. %, more than or equal to 15 wt. or more than or equal to 20 wt. % solvent.

### Preparing Silicone-Epoxy Compositions

To achieve the disclosed silicone-epoxy compositions and coatings described herein, a preparation method comprising two separate components is used. The first component, or “liquid base”, comprises a silicone-epoxy resin, a rheology additive, and a defoaming agent. The density of the liquid base is in the range of 1.25-1.35 Kg/mL. The liquid base may also include a liquid UV absorber, organic solvents, metal oxides, an epoxy resin comprising an elastomer, and an algicide or fungicide. The second component, or “hardener”, comprises amino-based silane. The density of the hardener is in the range of 0.85-0.95 Kg/L.

Silicone-epoxy compositions and coatings described herein are prepared by combining the liquid base with the hardener. As explained above, a liquid base according to embodiments provided herein can include any combination of a silicone-epoxy resin, a metal oxide or phosphate, a biocide, a rheology additive, an ultraviolet absorber, a defoaming agent, an epoxy resin, and a solvent. The hardener comprises an amino-silane. The mixing ratio of the liquid base to the hardener can vary. The variation of the mixing ratio can depend on the concentration of the silicone-epoxy resin in the liquid base. After initial mixing, the obtained composition must be stirred until homogeneity is achieved. This process is explained in more detail in the Examples provided below.

In some embodiments, the composition may comprise 70-90 wt. % or 80-90 wt. % liquid base. In some embodiments, the composition may comprise less than or equal to 90 wt. %, less than or equal to 85 wt. %, less than or equal to 80 wt. %, or less than or equal to 75 wt. % liquid base. In some embodiments, the composition may comprise more than or equal to 70 wt. %, more than or equal to 75 wt. %, more than or equal to 80 wt. %, or more than or equal to 85 wt. % liquid base. In some embodiments, the composition may include 10-30 wt. % hardener. In some embodiments, the composition may include of less than or equal to 30 wt. %, less than or equal to 25 wt. %, less than or equal to 20 wt. %, or less than or equal to 15 wt. % hardener. In some embodiments, the composition may include more than or equal to 10 wt. %, more than or equal to 15 wt. %, more than or equal to 20 wt. %, or more than or equal to 25 wt. % hardener.

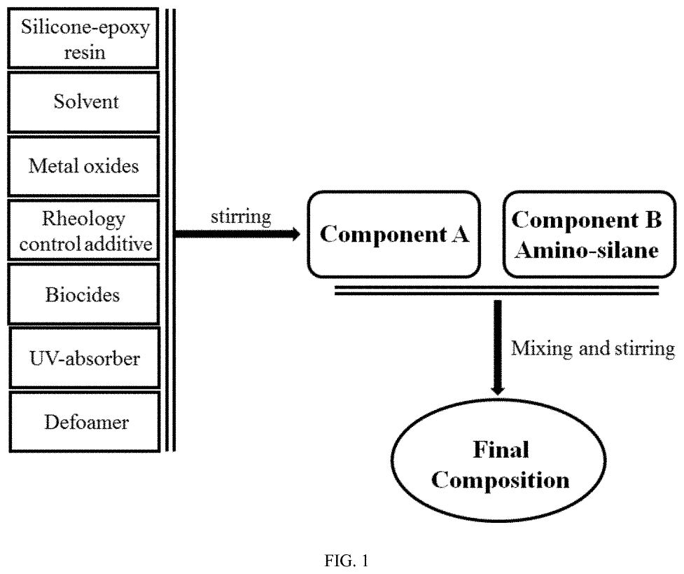

This mixing process is shown schematically in FIG. 1. As shown, the components of the liquid base are mixed altogether. The hardener (i.e., amino-silane) is added to the liquid base and mixed altogether to form the silicon-epoxy composition.

Table 1, below, shows examples of formulations based on the described two-component composition.

TABLE 1

| Liquid Base | | Hardener | |
|---|---|---|---|
| | Quantity | | Quantity |
| Raw material | (wt. %) | Raw material | (wt. %) |
| Silicone-epoxy resin | 65-90 | Amino-silane compound | 100 |
| Epoxy resin | 0.05-10 | | |
| Metal oxide or | 0.1-20 | | |
| phosphate | | | |
| Biocide | 0.1-10 | | |
| Rheology Modifier | 0.1-0.3 | | |
| UV Absorber | 0.1-1 | | |
| Defoaming Additive | 0.2-0.4 | | |
| Organic Solvent | 9-20 | | |

### Protective Coatings

The above-described silicone-epoxy compositions can be used to prepare protective coatings used for marine, industrial, and/or aviation applications, including, but not limited to, hydro-energy plants penstocks, wind energy converters, manned or unmanned aerial vehicles, rotors, offshore platforms, vessels, and/or fans/propellers that transmit power. Discussed below are various application/deposition methods for preparing protective coatings.

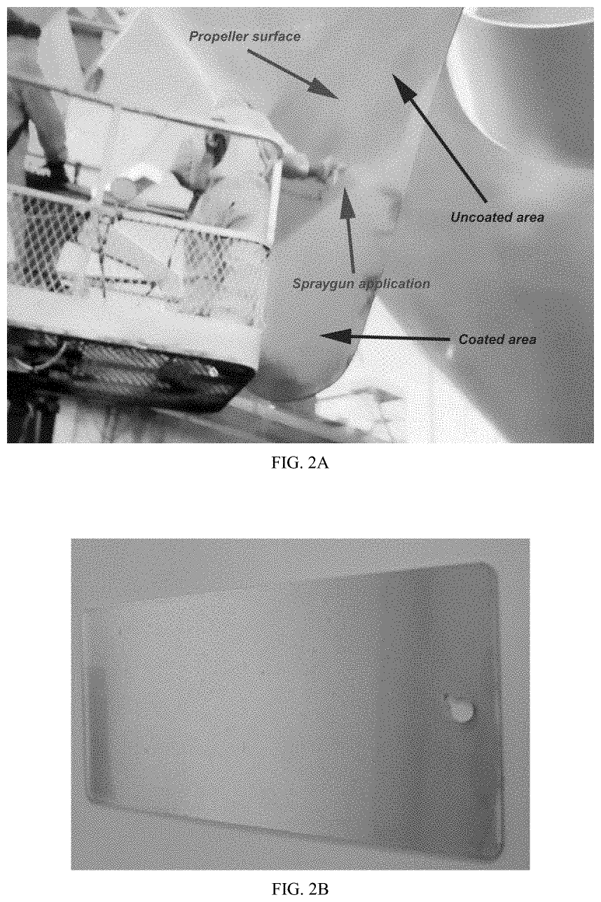

FIG. 2A shows a silicone-epoxy composition according to embodiments described herein that has been applied to a propeller (metallic surface). FIG. 2B shows a silicone-epoxy composition according to embodiments described herein that has been applied to an aluminum test plate substrate. In both Figures, the composition was applied using a conventional spraying method (e.g., paint pressure pot with power agitator, double air regulators, moisture trap, ½″ ID fluid hose, 5/16″ ID air hose, DeVilbiss 510 gun, “E” tip and needle, 74 or 78 air cap, airless spraying (minimum pump: 30:1, nozzle orifice size: 0.0013″-0.0019″), brushing). Other applications and deposition methods are provided below in the Examples.

Substrates coated with the silicone-epoxy compositions provided herein may have decreased roughness. A reduced roughness can improve aerodynamics and fuel efficiency. According to The American Society of Mechanical Engineers (ASME) publication Y14.36-2018: Surface Texture Symbols, the roughness (R_{z}) is the average distance between the highest peak and lowest valley in each sampling length. In some embodiments, the roughness of a substrate coated with a silicone-epoxy composition provided herein may be 10-60 μm, 20-50 μm, or 30-40 μm. In some embodiments, the roughness of a substrate coated with a silicone-epoxy composition provided herein may be less than or equal to 60 μm, less than or equal to 50 μm, less than or equal to 40 μm, less than or equal to 30 μm, or less than or equal to 20 μm. In some embodiments, the roughness of a substrate coated with a silicone-epoxy composition provided herein may be more than or equal to 10 μm, more than or equal to 20 μm, more than or equal to 30 μm, more than or equal to 40 μm, or more than or equal to 50 μm.

### Example 1

In a 200 L stainless-steel reactor, the liquid base is prepared by combining 127.50 kg of SILIKOPON® EF and 0.45 kg of TEGO® Flow 425. These components were added and mixed with 21.15 kg butyl acetate. The mixture was stirred at 600 rpm for 20 minutes. Subsequently, 0.45 kg of Tinuvin®400 and 0.45 kg BYK-A 500 are added while stirring. The mixture is mixed for an additional 25 minutes.

A hardener, Dynasylan® AMEO, is added such that it comprised 20 wt. % of the total mixture. The mixture was stirred until homogeneity is achieved (i.e., the composition was mixed thoroughly by using a motor blade mixer for 5±4 minutes). If the mixture is not mixed sufficiently, the resulting coating will not perform to specifications. The mixture was allowed an induction time of 20±15 minutes at an ambient temperature of 20° C. (68° F.). (A temperature increase of 10° C. will decrease the reported time intervals in half).

The composition was applied to a dry and clean surface using an airless spraying gun (Airless sprayer—Paint pressure pot with power agitator, double air regulators, moisture trap, ½″ ID fluid hose, 5/16″ ID air hose, DeVilbiss 510 gun, “E” tip and needle, 74 or 78 air cap. Minimum: 30:1 pump, Nozzle: 19-23). The preparation of the surface was completed according to ISO 8502-3:1992, and the surface was tested for cleanliness. The composition was applied to the surface at a temperature above the dew point to avoid condensation. The airless spraying gun was used with a nozzle tip (inch/1000) of 13-19 and a pressure at Nozzle (minimum) of 150 bar/2100 psi. Adequate ventilation was provided during application and drying, and the application took place at temperatures above 5° C. (32° F.). The temperature of the surface and that of the final composition itself was also above this limit. Curing requires a relative humidity of 30-85%. Windy weather conditions might adversely affect the end coating properties. To adequately apply the composition to the surface, the spray gun trigger was squeezed while the gun was off to the side of the application area, and then the spray gun was moved onto the work. The spraying gun was moved parallel to the surface and kept perpendicular to the surface. Additionally, the spraying gun was moved quickly over the surface to prevent runs or final composition sagging. The final wet film thickness was less than 150 microns, and spraying strokes overlapped about 20 to 30 percent. The coating was cured as ambient conditions for a minimum of 140 hours to yield the final coating surface of Example 1.

### Example 2

In a 200 L stainless-steel reactor, a liquid base was prepared by combining 132.00 kg of SILIKOFTAL® ED and 0.45 kg of TEGO® Glide 100. These components were added and mixed with 16.80 kg butyl acetate. The mixture was stirred at 600 rpm for 20 minutes. Subsequently, 0.30 kg of Tinuvin® 400 and 0.45 kg TEGO® Foamex 825 are added while stirring. The mixture is mixed for an additional 25 minutes at 600 rpm.

A hardener, Gelest® SIB1833.0, was added to the mixture such that the hardener comprised 20 wt. % of the total composition. Once the hardener was added, the composition was stirred until homogeneity is achieved. This included mixing thoroughly by using a motor blade mixer for 5±4 minutes. If adequate mixing is not reached, the resulting coating will not perform to specifications. The mixture was allowed an induction time of 20±15 minutes at an ambient temperature of 20° C. (68° F.). (A temperature increase of 10° C. will decrease the reported time intervals in half).

The composition was applied to a dry and clean surface using an airless spraying gun (Airless sprayer—Paint pressure pot with power agitator, double air regulators, moisture trap, ½″ ID fluid hose, 5/16″ ID air hose, DeVilbiss 510 gun, “E” tip and needle, 74 or 78 air cap. Minimum: 30:1 pump, Nozzle: 19-23). The preparation of the surface was completed according to ISO 8502-3:1992, and the surface was tested for cleanliness. The composition was applied to the surface at a temperature above the dew point to avoid condensation. The airless spraying gun was used with a nozzle tip (inch/1000) of 13-19 and a pressure at Nozzle (minimum) of 150 bar/2100 psi. Adequate ventilation was provided during application and drying, and the application took place at temperatures above 5° C. (32° F.). The temperature of the surface and that of the final composition itself was also above this limit. Curing requires a relative humidity of 30-85%. Windy weather conditions might adversely affect the end coating properties. To adequately apply the composition to the surface, the spray gun trigger was squeezed while the gun was off to the side of the application area, and then the spraying gun was moved onto the work. The spraying gun was moved parallel to the surface and kept perpendicular to the surface. Additionally, the spraying gun was moved quickly over the surface to prevent runs or final composition sagging. The final wet film thickness was less than 150 microns, and spraying strokes overlapped about 20 to 30 percent. The coating was cured as ambient conditions for a minimum of 140 hours to yield the final coating surface of Example 2.

### Example 3

In a 1000 L stainless-steel reactor, a liquid base was prepared by mixing 150.00 kg of SILIKOPON® EF, 7.50 kg of TEGO® Dispers 710, 40.00 kg AEROSIL® 200, 32.00 kg titanium dioxide, and 163.10 kg zinc oxide at 1200 rpm for 120 minutes. Subsequently, 250.00 kg of SILIKOPON® EF, 50.00 kg of 4,5-Dichloro-2-octylisothiazol-3(2H)-one, 90.00 kg of ALBIDUR® EP 2240 A, and 15.00 kg of TEGO® Foamex 825 were added. The mixture was mixed for an additional 20 minutes at 600 rpm.

A hardener, Dow Corning® Z-6011, was added to the mixture such that it comprised 14 wt. % of the total mix. The composition was stirred until homogeneity was achieved by mixing thoroughly by using a motor blade mixer for 5±4 minutes. If sufficiently mixing is not reached, the resulting coating will not perform to specifications. The mixture was allowed an induction time of 20±15 minutes at an ambient temperature of 20° C. (68° F.). (A temperature increase by 10° C. will decrease the reported time intervals in half).

The composition was applied to a dry and clean surface using an airless spraying gun (Airless sprayer—Paint pressure pot with power agitator, double air regulators, moisture trap, ½″ ID fluid hose, 5/16″ ID air hose, DeVilbiss 510 gun, “E” tip and needle, 74 or 78 air cap. Minimum: 30:1 pump, Nozzle: 19-23). The preparation of the surface was completed according to ISO 8502-3:1992, and the surface was tested for cleanliness. The composition was applied to the surface at a temperature above the dew point to avoid condensation. The airless spraying gun was used with a nozzle tip (inch/1000) of 13-19 and a pressure at Nozzle (minimum) of 150 bar/2100 psi. Adequate ventilation was provided during application and drying, and the application should only take place at temperatures above 5° C. (32° F.). The temperature of the surface and that of the final composition itself was also above this limit. Curing requires a relative humidity of 30-85%. Windy weather conditions might adversely affect the end coating properties. To adequately apply the composition to the surface, the spray gun trigger was squeezed while the gun was off to the side of the application area, and then the spraying gun was moved onto the work. The spraying gun was moved parallel to the surface and kept perpendicular to the surface. Additionally, the spraying gun was moved quickly over the surface to prevent runs or final composition sagging. The final wet film thickness was less than 150 microns, and spraying strokes overlapped about 20 to 30 percent. The coating was cured as ambient conditions for a minimum of 140 hours to yield the final coating surface of Example 3.

### Example 4

The hydrodynamic performance was tested with a hull of a vessel coated with a silicone-epoxy composition according to embodiments provided herein. Hydrodynamic performance of coatings under in-service conditions corresponds to the vessel operating costs. Taking into account that 80% of the available energy in ships is used to overcome hydrodynamic forces, the hull resistance is of high importance, directly affecting the speed, power requirements and fuel consumption. The main objective is to achieve drag reduction on marine vessels. Hydrodynamic drag is the force of an object as it moves through a fluid. In other words, the goal is to optimize hydrodynamic performance by reducing the total resistance. Any decrease in the underwater hull roughness will make a significant reduction in operating costs. Therefore, the surface characteristics obtained from a coating reflect directly to hydrodynamic performance.

This disclosure relates to silicone-epoxy protective coating characterized as a foul-release system, with an ultra-smooth surface. Also, the surface coated with the silicone-epoxy foul-release system presents lower resistance. Thus, hydrodynamic model tests were performed to evaluate the hydrodynamic performance of the silicone-epoxy coating presented in this invention. A wooden model was constructed for this purpose (see FIG. 3). The scale ratio of the model was 1:22,222, according to C/P RODOS vessel. The vessel characteristics and model characteristics are presented in Table 2, below.

TABLE 2
Characteristics presented for the vessel
C/P RODOS and the used model.

| Characteristics | Vessel - C/P RODOS | Model |
|---|---|---|
| Displacement Δ | 9075.97 (tn) | 806.90 (kg) |
| Length at waterline L_{WL} (m) | 124.38 | 5.597 |
| Beam at waterline B_{WL} (m) | 21.20 | 0.954 |
| Draught above BL Tₘ (m) | 6.20 | 0.279 |
| Wetted surface (m²) | 2816.24 | 5.703 |

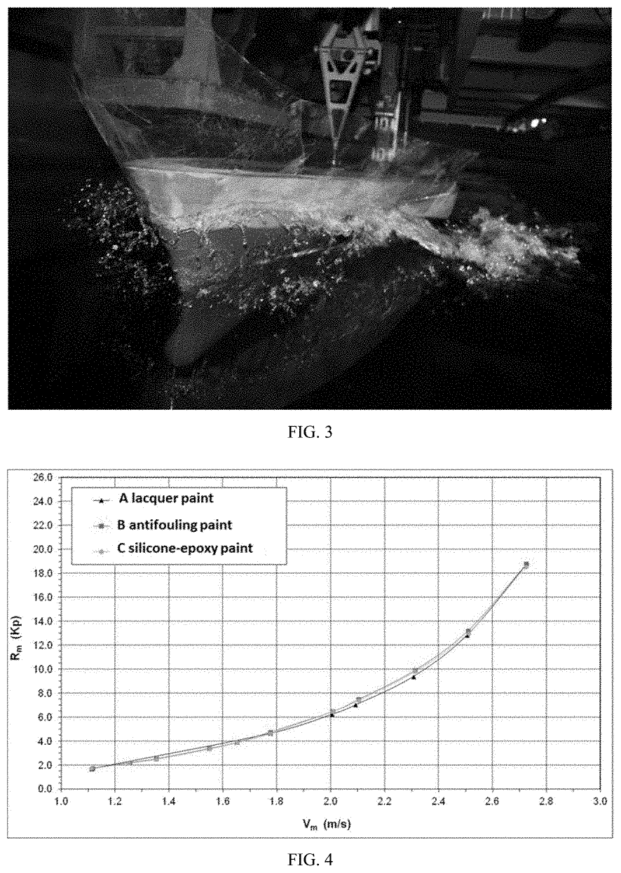

The experiments were performed in a towing tank having an effective length of 91 m, a width of 4.56 m, and a depth of 3.00 m. The model was connected to a dynamometer, and the speed covered the range of 10 to 25 knots. During the resistance tests, the calm water resistance, the shrinkage at the point of attachment to the dynamometer, the dynamic trim, and the towing speed of the model were recorded during each run. During testing, three conditions were evaluated: (1) the model was painted with conventional lacquer (a conventional lacquer means a glossy wood coating, which in this embodiment stands for a polyurethane. Polyurethane coatings may present a smooth finish but their low water resistance does not permit application as a hull coating), (2) the model was painted with conventional antifouling, self-polishing, hull coating, and (3) the model was painted with the foul-release silicone-epoxy coating of the present disclosure. The model calm water resistance versus speed is shown in FIG. 4. The results show that the hydrodynamic resistance of the model painted with the silicone-epoxy coating was reduced compared to the antifouling coating. The average reduction rate was 1.6%, when compared to both the conventional lacquer and the conventional antifouling, self-polishing, hull coating. These results correlate the effect of hull roughness directly (due to different coatings) with the resistance and effective power of a vessel in full-scale.

### Example 4

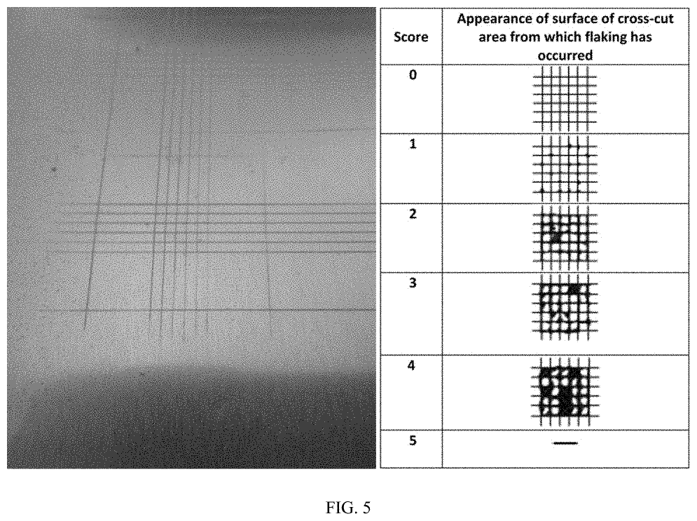

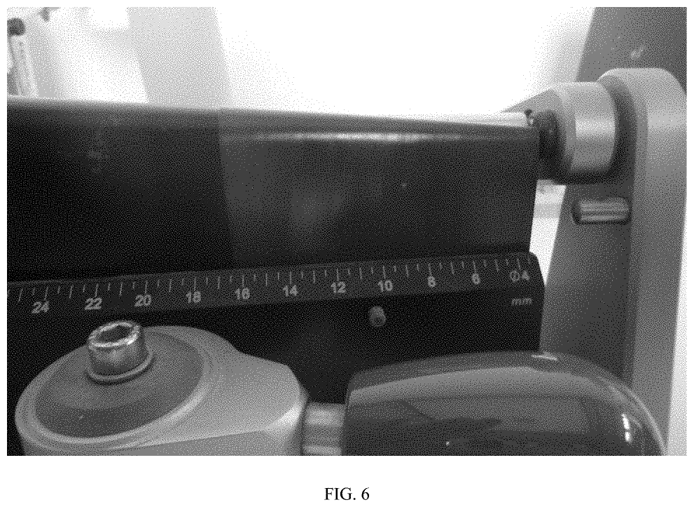

The disclosed silicone-epoxy protective coatings present excellent adhesive properties on metallic surfaces. The disclosed coatings also provide improved water and abrasion resistance. Specifically, the coating was tested with cross-cut adhesion tester (as per ISO 2409:2013 Paints and varnishes Cross-cut test) and cylindrical bend tester (as per ISO 1519:2011Paints and varnishes Bend test (cylindrical mandrel)). FIG. 5 shows the results from cross-cut adhesion tester testing a coating prepared using a silicone-epoxy composition, alongside with the evaluation scheme, as per ISO 2409:2013 (Paints and varnishes Cross-cut test). In this embodiment, the final coating includes silicon-epoxy resin in mass percentage less or equal to 85%, and the final coating is transparent. As shown in FIG. 5, the score as per ISO 2409:2013 is 0 (zero-no flaking), which means that the coating has sufficient adhesion to metal (ferrous) substrates. FIG. 6 shows the results from cylindrical bend tester testing a coating prepared using a silicone-epoxy composition. In this embodiment, the final coating includes silicon-epoxy resin in mass percentage less or equal to 65%, antifouling agent more or equal to 9%, and iron oxide as dye less or equal to 20%. The coating in this embodiment is tinted red-brown for better visibility of any potential cracks. The cylindrical bend tester revealed that the cracking point is developed at a 3 mm radius (FIG. 6).

### Example 5

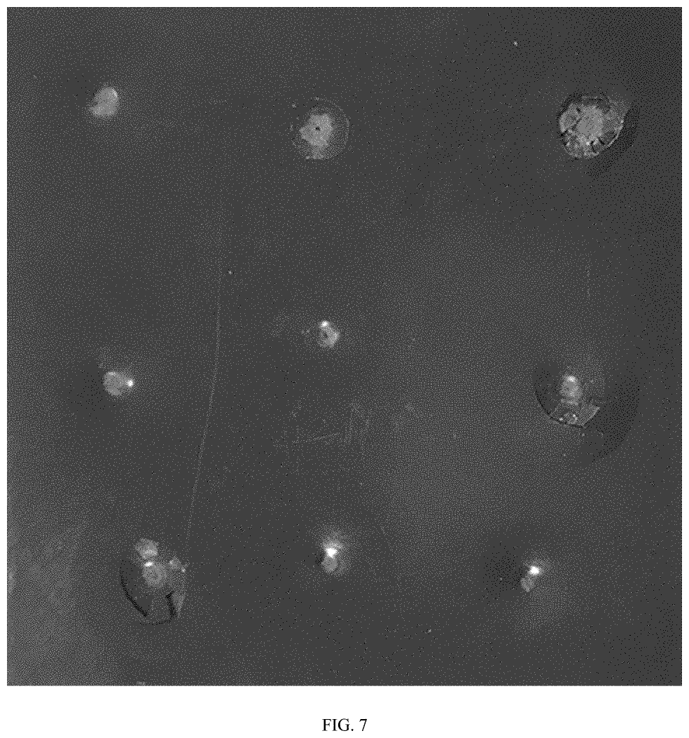

An impact tester (as per ISO 6272-2:2011 Paints and varnishes Rapid-deformation (impact resistance) tests Part 2: Falling-weight test, small-area indenter) was employed to evaluate the resistance of the disclosed silicone-epoxy protective coating surface to impact forces. According to the testing procedure, the test specimen was fixed into position by a quick-release clamp. The weight was lifted to the predetermined height and set by the adjustable collar device. The weight was then released, and the resulting deformation observed. The weight was set at 1 kg; the lift height was set at 1 m and hemispherical punch diameter at 12.7 mm. As per the experimental conditions, 9.8 J of energy is distributed over a surface area of 127 mm². For the disclosed silicon-epoxy coating surface of a dry film 120 m thick, the impact craters have an average size of 4.1±1.0 mm. Three out of nine of the impact points have delaminated, as illustrated in FIG. 7. Delamination of the samples is not considered an alarming fact as it took place next to the sample edges: Those points have a limited ability to absorb impact energy, as there is less coating mass surrounding the impact point. In this embodiment, the final coating includes silicon-epoxy resin in mass percentage less or equal to 65%, antifouling agent less or equal to 9%, and iron oxide as dye less or equal to 20%.

### Example 6

The accelerated weathering tester reproduces the damage caused by sunlight, rain, and dew. After 3.000 h of testing, the tester can reproduce the damage that occurs over ten years of operational life. To simulate outdoor weathering, the accelerated tester exposes a coated substrate to alternating cycles of UV light and moisture at controlled, elevated temperatures. It simulates the effects of sunlight using special fluorescent UV lamps. It simulates dew and rain with condensing humidity and water spray. Coatings of the disclosed silicone-epoxy protective coating formulations were exposed under UV-B (Q-Lab QUV chamber equipped with UVB-313 lamps with emission max at 313 nm) testing for 3.500 h. No cracking, yellowing, coating defect (as defined in Fitz's Atlas 2 of coating defects, by Brendan Fitzsimons ISBN: 0951394029), or any loss of original properties was revealed, indicating that the useful lifetime of the resulting coating exceeds ten years.

### Example 7

The accelerated salt spray (or salt fog) test is a standardized and simplified corrosion test method used to check corrosion resistance of surface coatings. Salt spray testing is an accelerated corrosion test that produces a corrosive attack to coated samples to evaluate the suitability of the coating for use as a protective finish. The appearance of corrosion products (rust or other oxides) is evaluated after 1.008 h of exposure. Testing was performed using a Q-Lab Q-Fog SSP, under the ISO 9227:2017 (Corrosion tests in artificial atmospheres Salt spray tests). Ten (10) metal, evaluation specimen panels (Grade E24, Dimensions: 150 mm×150 mm×6 mm) were finished with 150 m thick (dry coating thickness) coating of the disclosed silicone-epoxy protective coating formulation, to provide a degree of corrosion protection to the underlying metal. The average mass loss of the ten evaluated specimens was determined at 0.23%, with a standard deviation of ±0.02%, using an analytical scale and comparing the mass before and after accelerated salt spraying testing, indicating that the useful lifetime of the resulting coating exceeds ten years, in a marine environment.

### Example 8

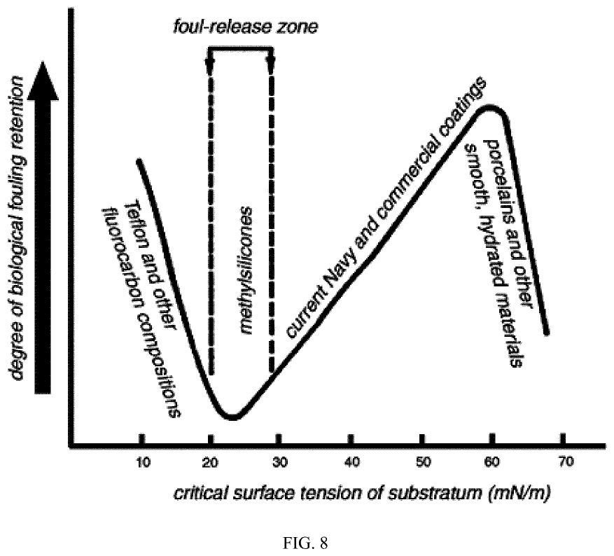

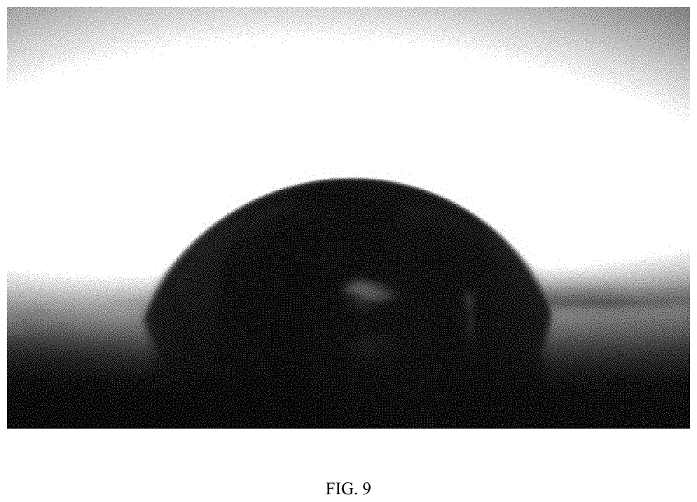

The fouling release properties of the disclosed silicone-epoxy protective coating are promoted by the shear force created by the movement of a ship. A simple way to measure the shear force is with force plates. A force plate is designed to measure the forces and moments applied to its top surface as a subject stand, steps, or jumps on it (in the present case seawater). Robert E. Baier established an empirical correlation between the adhesion of fouling organisms and the critical surface tension, widely known as the Baier curve (FIG. 8): There is a dip at the critical surface tension of 22-24 mN/m where naturally the lowest amount of marine biofouling has been observed. This value is close to the dispersive component of the surface energy of water and matches well with the surface energy of the disclosed silicone-epoxy protective coating. In other words, the thermodynamic energy penalty for creating an interface between silicones and water can be minimized when a fouling organism is removed from the surface, and the water is re-wetting the surface. The surface of the resulting coating is hydrophobic. The contact angle between water and the resulting coating is 720 (FIG. 9). The contact angle is the angle where a liquid-vapor interface meets a solid surface. It quantifies the wettability of a solid surface. Interpretation of the contact angle measurement results in a critical surface energy value of 22 mN/m, underlining that the disclosed silicone-epoxy protective coating presents fouling release properties.

### Example 9

For correlation reasons (roughness versus resistance), the measured roughness R_{z} (R_{z} is the average distance between the highest peak and lowest valley in each sampling length, The American Society of Mechanical Engineers (ASME) publication Y14.36-2018: Surface Texture Symbols) for the antifouling coating was measured R_{z}=124 μm, whereas for the silicone-epoxy coating R_{z}=36 μm. The measurements of roughness were performed with a portable surface roughness tester (Mitutoyo Surftest SJ-201).

### Example 10

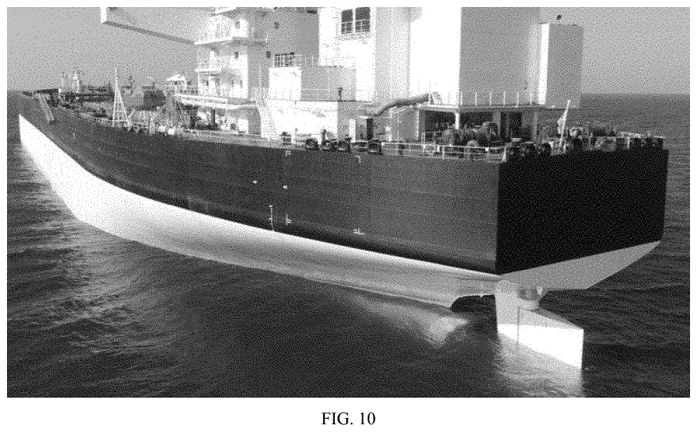

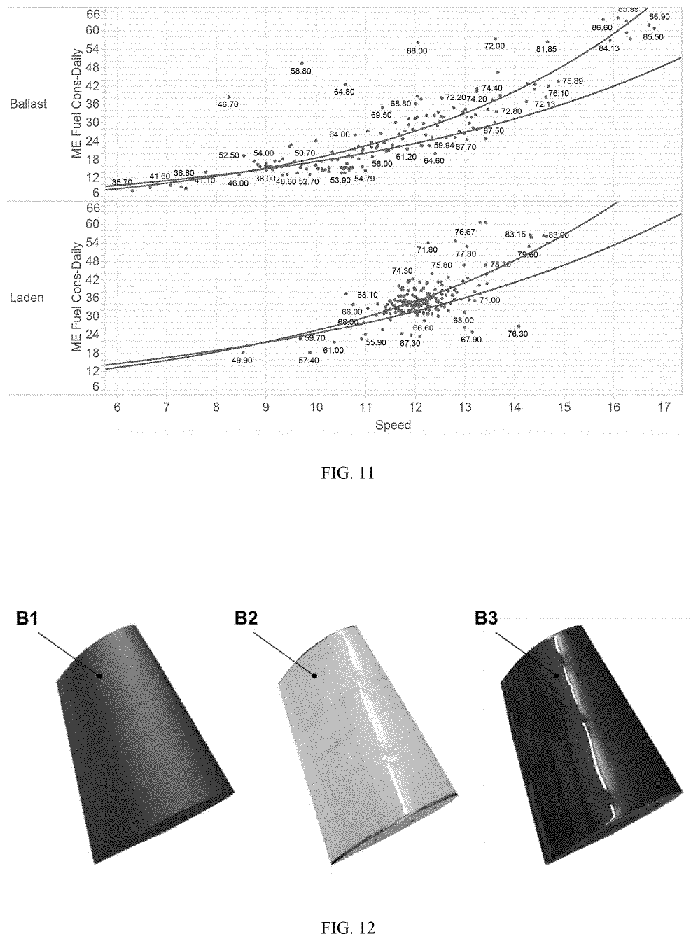

To evaluate the performance of the coating resulting from the disclosed invention herein, a Suezmax tanker vessel was applied to the coating as mentioned above on her hull (FIG. 10, white hull coating). In this embodiment, the final coating includes from silicon-epoxy resin in mass percentage more or equal to 60%, epoxy resin less or equal to 5%, antifouling agent less or equal to 9.5%, rheology control additives more or equal to 1%, dispersants more or equal to 1.5%, fumed silica less or equal to 1.5%, zinc oxide more or equal to 4%, solventless or equal to 0.5% and titanium oxide less or equal 19%. FIG. 11 shows an evaluation based on the average fuel consumption over six months as a function of the vessel's speed in the water. The blue line and points represent the conditions after the application of coatings, resulting from the present invention. The red line and points represent the conditions after the application of a self-polishing (cuprous oxide based), conventional coating. Data acquisition took place six months after the application of each coating system (June 2015 to November 2015 for the self-polishing (cuprous oxide based), conventional coating scheme, and August 2019 to January 2020 for the coating resulting from the disclosed invention herein). The datasets are grouped in two sets: laden conditions (lower half of the graph—the state of a vessel when charged with materials equal to her capacity) and ballast conditions (upper half of the figure—travel empty or partially empty to collect a cargo-travel in ballast. This keeps the vessel in trim, and holds the propeller and rudder submerged. Being “in ballast” means flooding the ballast tanks with seawater.) The results show a fuel savings of around 6tn daily or 21.5% (Ballast conditions) and a fuel savings of about 4tn daily or 11.5% (Laden conditions).

### Example 11

As the coatings resulting from the present invention are applied to structures moving in fluid media (both water and air (gas)), an experimental evaluation on the aerodynamic performance of coated airfoils was performed. In this embodiment, the final coating includes silicon-epoxy resin in mass percentage more or equal to 85%, solvent more or equal to 10% rheology modifier more or equal to 0.5% and UV-absorber more or equal to 0.2%. Specifically, asymmetric airfoils (NLF1015, lift producing, B series of specimens, shown in FIG. 12) were used for the aerodynamic assessment. Three airfoil models were prepared: the first one is coated with a conventional, polyurethane-based aviation coating (B1 on asymmetric airfoil, as shown in FIG. 12), the second is coated with a transparent silicone-epoxy formulation according to embodiments provided herein. For the second airfoil, the silicone-epoxy formulation is applied directly to the body of the airfoils (B2 on the asymmetric airfoil, as shown in FIG. 12) and the third is coated with a transparent silicone-epoxy formulation according to embodiments provided herein. For the third airfoil, the silicone-epoxy formulation was applied to the conventional, polyurethane-based aviation coating of B1 (B3 on asymmetric airfoil, as shown in FIG. 12). Each airfoil has a chord of 300 mm and a span of 600 mm. The experiments were conducted in a closed-circuit, low-speed wind tunnel facility at a freestream air velocity of 8.7 m/s (31.2 km/h), at a wide range of airfoil angles of attack (from −6° to 100 at 2° intervals). The criteria used for the investigation of the aerodynamic performance was the normalized lift and drag coefficients.

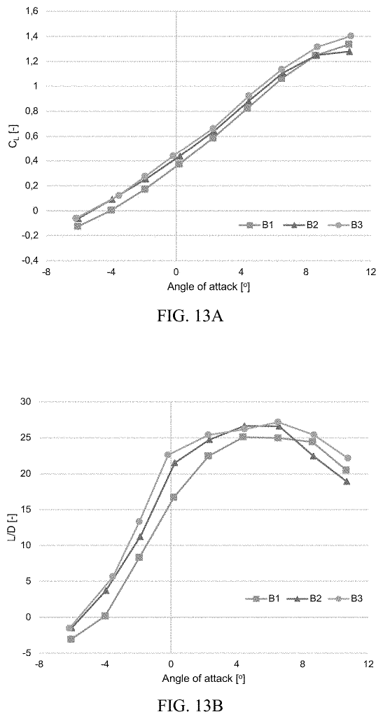

FIG. 13A shows lift coefficient data for the three asymmetric airfoils depicted in FIG. 12. According to the data shown in FIG. 13A, the lift coefficient appears increased (about 0.05 units for each of the examined angles of attack) on the coated airfoils (B2 and B3) as compared to the uncoated B1 airfoil. However, the lift-curve slope shape remains unaffected in the coated airfoils. The increase also affects the maximum lift coefficient. The maximum lift coefficient of airfoils B2 and B3 is increased by 6%, compared to the uncoated airfoil. Regarding the drag coefficient, it remains practically unaffected for all three airfoils, from −1 up to +6 degrees (difference less than 0.5%). At angles of attack less than −1°, airfoil B1 shows an 8% increase in drag coefficient, while at angles of attack greater than 8°, the coated airfoil B2 is the one having an increased drag coefficient, by 9%.

FIG. 13B shows the aerodynamic efficiency ratio (lift-to-drag ratio or L/D). The L/D ratio of airfoil B3 appears constantly increased by about four units, compared to airfoil B1, across the entire angle-of-attack range. Airfoil B2 presents a similar behavior, except for the 8° and 10° angles, where its aerodynamic efficiency is reduced. The aerodynamic data suggest that the coatings developed based on embodiments provided present better aerodynamic characteristics and can be used in airfoil coating applications.

The preceding description sets forth exemplary methods, parameters, and the like. It should be recognized, however, that such description is not intended as a limitation on the scope of the present disclosure but is instead provided as a description of exemplary embodiments. The illustrative embodiments described above are not meant to be exhaustive or to limit the disclosure to the precise forms disclosed. Many modifications and variations are possible in view of the above teachings. The embodiments were chosen and described to explain best the principles of the disclosed techniques and their practical applications. Others skilled in the art are thereby enabled to utilize the techniques best, and various embodiments with various modifications as are suited to the particular use contemplated.

Although the disclosure and examples have been thoroughly described with reference to the accompanying figures, it is to be noted that various changes and modifications will become apparent to those skilled in the art. Such changes and modifications are to be understood as being included within the scope of the disclosure and examples as defined by the claims. In the preceding description of the disclosure and embodiments, reference is made to the accompanying drawings, in which are shown, by way of illustration, specific embodiments that can be practiced. It is to be understood that other embodiments and examples can be practiced, and changes can be made without departing from the scope of the present disclosure.

Although the preceding description uses terms first, second, etc. to describe various elements, these elements should not be limited by the terms. These terms are only used to distinguish one element from another.

Also, it is to be understood that the singular forms “a,” “an,” and “the” used in the preceding description are intended to include the plural forms as well unless the context indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The term “if” may be construed to mean “when” or “upon” or “in response to determining” or “in response to detecting,” depending on the context.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

1. A silicone-epoxy coating formulation composition comprising:
45 to 80 wt. % silicone-epoxy resin;
0.05 to 10 wt. % biocide;
0.05 to 0.3 wt. % rheology additive;
5 to 18 wt. % solvent; and
10 to 30 wt. % amino-silane.

2. The composition of claim 1, wherein the rheology additive comprises at least one of TEGO® Flow 425, TEGO® Glide 100, or AEROSIL® 200.

3. The composition of claim 1, wherein the solvent comprises at least one of butyl acetate, xylene, methoxy propyl acetate, or glycol esters.

4. The composition of claim 1, comprising 0.05 to 1 wt. % ultraviolet absorber.

5. The composition of claim 4, wherein the ultraviolet absorber comprises at least one of Tinuvin® 400 or Tinuvin® 1130 or Milestab© 234.

6. The composition of claim 1, comprising 0.1 to 0.4 wt. % defoaming additive.

7. The composition of claim 6, wherein the defoaming additive comprises at least one of BYK®-A 500 or TEGO® Foamex 810 or TEGO® Foamex 825 or TEGO® Foamex 830.

8. The composition of claim 1, comprising 0.05 to 20 wt. % metal oxide or phosphate.

9. The composition of claim 1, comprising 0.05 to 10 wt. % epoxy resin comprising an elastomer.

10. A silicone-epoxy coated substrate comprising:
a substrate; and
a coating on the substrate, the coating comprising:
70 to 95 wt. % amino-silane cross-linked silicone-epoxy resin;
0.05 to 12 wt. % biocide; and
0.05% to 0.4 wt. % rheology additive.

11. The coated substrate of claim 10, wherein the rheology additive comprises at least one of TEGO® Flow 425, TEGO® Glide 100, or AEROSIL® 200.

12. The coated substrate of claim 10, comprising 0.05 to 25 wt. % metal oxide or phosphate.

13. The coated substrate of claim 10, comprising 0.05 to 1.5 wt. % ultraviolet absorber.

14. The coated substrate of claim 13, wherein the ultraviolet absorber comprises at least one of Tinuvin® 400 or Tinuvin® 1130 or Milestab© 234.

15. The coated substrate of claim 10, comprising 0.1 to 0.5 wt. % defoaming additive.

16. The coated substrate of claim 15, wherein the defoaming additive comprises at least one of BYK®-A 500 or TEGO® Foamex 810 or TEGO® Foamex 825 or TEGO® Foamex 830.

17. The coated substrate of claim 10, wherein the coating has a roughness R_{z} of less than 30 micrometers.

18. The coated substrate of claim 10, wherein the substrate comprises one or more of a hydro-energy plant penstock, a wind energy converter, a manned or unmanned aerial vehicle, an airfoil, a vehicle fuselage, a rotor, an offshore platform, a vessel, or a fan/propeller that transmits power.

19. The coated substrate of claim 10, comprising a roughness (R_{z}) of less than 50.

20. The coated substrate of claim 10, comprising a roughness (R_{z}) of less than 40.
